(19) United States
(12) Patent Application Publication
(10) Pub. No.: US 2025/0248567 A1
(43) Pub. Date: Aug. 7, 2025

(54) WIPER ATTACHMENT LOCATING ON A STAND MIXER APPLIANCE

(71) Applicant: Haier US Appliance Solutions, Inc., Wilmington, DE (US)

(72) Inventors: Andrew Pierce, Louisville, KY (US); Joseph Mazzella, Louisville, KY (US)

(21) Appl. No.: 18/431,062

(22) Filed: Feb. 2, 2024

(51) Int. Cl. A47J 43/07; A47J 43/044

(52) U.S. Cl. CPC A47J 43/0711; A47J 43/044; A47J 2043/0449

(57) ABSTRACT

A stand mixer includes a housing and a motor disposed in the housing. The stand mixer also includes a mixing shaft operably coupled to the motor and a gear cover coupled around the mixing shaft. A wiper attachment is removably coupled to the gear cover. The wiper attachment includes a seat portion and a blade extending from one end of the seat portion. The seat portion includes a floor extending between a pair of opposing sidewalls. The floor defines a semicircular opening at a distal end of the seat portion from the blade. The pair of opposing sidewalls and the semicircular opening of the seat portion of the wiper attachment are configured to engage with the gear cover in order to securely couple the wiper attachment to the gear cover.

### FIELD OF THE INVENTION

The present subject matter relates generally to systems for locating attachments on stand mixers.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various attachments to the one or more driveshafts to perform a variety of functions. The attachments, such as a beater, whisk, or hook, may be removably mounted to the driveshafts, such that the attachments may rotate within a bowl to beat, whisk, knead, etc., material within the bowl.

The attachments may be shaped in various ways to perform desired operations, such as removing ingredients from the side of the bowl during a mixing process. Removing ingredients that get stuck on the side of the bowl during mixing may be beneficial for mixing performance. Traditional mixer attachments to achieve this benefit may be unstable and do not maintain contact with the bowl during mixing. Accordingly, a stand mixer attachment configured to securely attach to the stand mixer and make consistent contact with the bowl would be advantageous.

### BRIEF DESCRIPTION OF THE INVENTION

Aspects and advantages of the invention will be set forth in part in the following description, or may be apparent from the description, or may be learned through practice of the invention.

In one example embodiment, a stand mixer is provided. The stand mixer defines a vertical direction, a lateral direction, and a transverse direction. The vertical, lateral, and transverse directions being mutually perpendicular. The stand mixer includes a housing and a motor disposed in the housing. The stand mixer also includes a mixing shaft operably coupled to the motor, and a gear cover coupled around the mixing shaft. A wiper attachment is removably coupled to the gear cover. The wiper attachment includes a seat portion and a blade extending from one end of the seat portion. The seat portion includes a floor extending between a pair of opposing sidewalls. The floor defines a semicircular opening at a distal end of the seat portion from the blade. The pair of opposing sidewalls, and the semicircular opening of the seat portion of the wiper attachment are configured to engage with the gear cover in order to securely couple the wiper attachment to the gear cover.

In another example embodiment, a wiper attachment for a stand mixer is provided. The wiper attachment defines a vertical direction, a lateral direction, and a transverse direction. The vertical, lateral, and transverse directions being mutually perpendicular. The wiper attachment is removably coupled to a gear cover of the stand mixer. The wiper attachment includes a seat portion and a blade extending from one end of the seat portion. The seat portion includes a floor extending between a pair of opposing sidewalls. The floor defines a semicircular opening at a distal end of the seat portion from the blade. The pair of opposing sidewalls, and the semicircular opening of the seat portion of the wiper attachment are configured to engage with the gear cover in order to securely couple the wiper attachment to the gear cover.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an example stand mixer with a bowl according to example embodiments of the present disclosure.

FIG. 2 provides a side view of the stand mixer with a mixing attachment according to example embodiments of the present disclosure.

FIG. 3 illustrates a perspective view of an example wiper attachment according to example embodiments of the present disclosure.

FIG. 4 illustrates a top schematic view of the example wiper attachment of FIG. 3 according to example embodiments of the present disclosure.

FIG. 5 illustrates a side, section view of the example wiper attachment of FIG. 3 attached to an example stand mixer according to example embodiments of the present disclosure.

FIG. 6 illustrates a perspective, section view of the example wiper attachment of FIG. 3 attaching to the example stand mixer of FIG. 5.

FIG. 7 illustrates another perspective, section view of the example wiper attachment of FIG. 3 attaching to the example stand mixer of FIG. 5.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

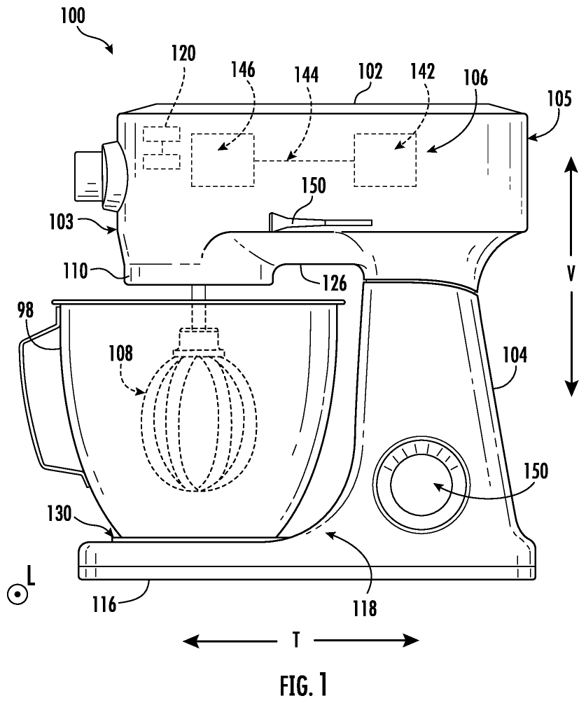

The present disclosure provides a mixer appliance with a secure mixing attachment coupling to a mixing shaft of the mixer appliance. This secure coupling may allow the mixer to rotate the shaft with the secured mixing attachment in clockwise and counterclockwise motions. The figures depict an example stand mixer appliance 100 that may be configured in accordance with various aspects of the present disclosure. It should be appreciated that the invention is not limited to any particular style, size, model, or shape for stand mixer appliance 100. The example embodiment in FIG. 1 is for illustrative purposes only. For example, appliance 100 may have different shapes and appearance for one or more parts, different motor and gear configurations, and other differences while remaining within the scope of the claimed subject matter.

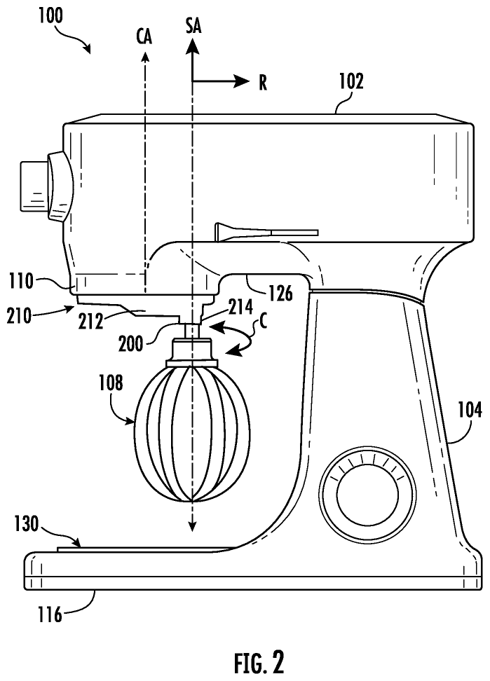

With reference for FIGS. 1 and 2, for the particular embodiment shown, a stand mixer appliance 100 includes a housing 102 and a base 104. Stand mixer 100 may extend between housing 102 and base 104 in a vertical direction V, across housing 102 in a lateral direction L, and from a front 103 to a back 105 in a transverse direction T. The vertical direction V, lateral direction L, and transverse direction T are perpendicular to one another.

Housing 102 may be pivotally mounted to base 104 and extends transversely between front 103 and back 105 of stand mixer appliance 100 when in the mixing position shown in FIG. 1. In some embodiments, housing 102 may be non-pivotably attached to base 104. Other configurations may be used where housing 102 may allow for access to a bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112. Horizontal base member 116 may include a scale 130. In some embodiments, scale 130 may be concave, grooved, or otherwise shaped to accept bowl 98. Scale 130 may be generally configured to weigh bowl 98 and the contents therein.

Housing 102 includes an attachment support 110. A motor 142 is disposed within the housing 102. Attachment support 110 is located on a lower portion or underside 126 of housing 102 and forward of upright support 112 along transverse direction T. A mixing shaft 200 extends from attachment support 110. Removable mixing attachment 108 removably attaches to shaft 200. Additionally, a gear cover 210 may couple around mixing shaft 200 and extend beneath attachment support 110, e.g., below lower portion or underside 126 of housing 102. In general, gear cover 210 may include a body portion 212 and a round shaft portion 214, as will be explained in further detail hereinbelow.

Drivetrain 144 connects motor 142 with one or more gears 146 for causing rotation of attachment 108 or mixing shaft 200, e.g., mixing shaft 200 may be operably coupled to motor 142. Gears 146 may allow for selection by the user of different rotating speeds for attachment 108. In general, mixing attachment 108 may be coupled to shaft 200 prior to rotation of shaft 200 by motor 142.

Stand mixer 100 may include one or more controls 150 for operations such as selectively powering motor 142, choosing the speed of rotation for attachments 108, locking position of housing 102 relative to base 104 during mixing, or other features. In some embodiments, controls 150 may include a rotational direction operation selection, allowing a user to select the direction of rotation of the mixing shaft 200.

In certain embodiments, attachment support 110 may accept more than one attachment 108. Various types of attachments 108 may be used including e.g., whisks, paddles, dough hooks, beaters, and others for purposes of mixing articles or mechanically manipulating articles within bowl 98 or other containers supported by base 104. During use, attachment support 110 with mixing shaft 200 may rotate attachment 108 in a circular or planetary fashion. Spinning in a planetary fashion, as used herein, includes spinning an object (e.g., shaft 200) about a first axis and revolving the object around a second axis, the object offset from the second axis. For example, shaft 200 may spin about a shaft axis SA, and revolve around a central axis CA, shaft 200 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 200 may rotate within attachment support 110. Mixing attachment 108 and mixing shaft 200 are rotatable by motor 142 in planetary rotation. Mixing shaft may define the shaft axis SA, with a radial direction R extending therefrom perpendicular to the shaft axis SA, and a circumferential direction C extending around the central axis CA. Mixing shaft 200 may rotate around central axis CA, wherein mixing shaft 200 is rotating in circumferential direction C. Additionally or alternatively, motor 142 may be operable to selectively rotate mixing attachment 108 in a clockwise direction or a counterclockwise direction in circumferential direction C around shaft axis SA. Thus, mixing shaft 200 may be reversible, or moveable in either direction during use. Attachment of mixing attachment 108 to shaft 200 allows for motion in both directions, clockwise and counterclockwise, by motor 142. In other words, motor 142 can rotate mixing attachment 108 and/or shaft 200 in a clockwise direction and can switch and rotate mixing attachment 108 and/or shaft 200 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120. In particular, controller 120 may be located within housing 102. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may include a printed circuit board (PCB) with various components coupled thereto, as would be understood by those of ordinary skill in the art.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, controls 150 may include one or more microprocessors and/or one or more memory devices. Accordingly, certain components of stand mixer 100 may be controlled directly from controls 150. For example, controller 120 may be generally configured to perform a mixing operation/cycle, whereby stand mixer 100 may be operated to mix food contents, such as food contents in bowl 98.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

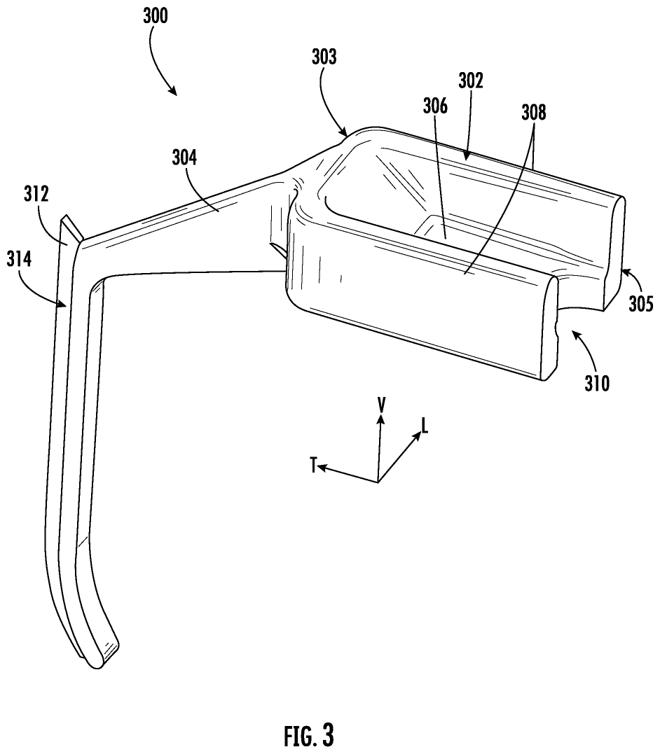

Turning now to FIG. 3, illustrated is a perspective view of an example wiper attachment 300. In general, wiper attachment 300 may be removably coupled to gear cover 210. In the present example embodiment, wiper attachment 300 may generally include a seat portion 302 and a blade 304 extending from one end 303 of seat portion 302. Wiper attachment 300 may generally include a scraper 312 positioned on, or extending from, an outer portion 314 of blade 304. Scraper 312 may be generally configured to continuously contact bowl 98 of stand mixer 100 during mixing processes. Additionally, scraper 312 may be a silicon or rubber type of material, e.g., any suitable flexible material, such that the flexibility of the material may allow greater tolerances in fitting the attachment within bowl 98, in that the flexible material of scraper 312 may bend to accommodate minor variations in positioning.

As shown in FIG. 3, seat portion 302 may include a floor 306 extending along a horizontal plane defined by the lateral direction L and transverse direction T, between a pair of opposing sidewalls 308, and floor 306 may define a semicircular opening 310 at a distal end 305 of seat portion 302 from blade 304 in the horizontal plane, e.g., end 203 and distal end 205 may be opposing ends of seat portion 302. In general, the pair of opposing sidewalls 308 and semicircular opening 310 of seat portion 302 of wiper attachment 300 may be configured to engage with gear cover 210 in order to securely, yet removably, couple wiper attachment 300 to gear cover 210, as will be explained in further detail hereinbelow.

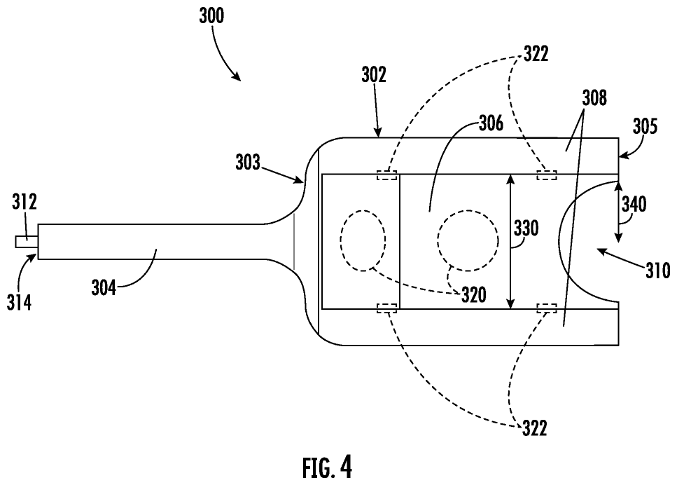

Turning now to FIG. 4, illustrated is a top, schematic view of wiper attachment 300. In some example embodiments, wiper attachment 300 may include one or more magnets 320 positioned within seat portion 302 of wiper attachment 300. In general, magnets 320 may be configured to removably engage with gear cover 210 in order to securely, yet removably, couple wiper attachment 300 to gear cover 210. For example, securely coupling wiper attachment 300 to gear cover 210 may include attaching wiper attachment 300 to gear cover 210 such that wiper attachment is configured to rotate with gear cover 210, and rotation and/or translation in other directions is reduced. Additionally or alternatively, some example embodiments may include one or more snaps 322 positioned on seat portion 302, or more specifically the pair of opposing sidewalls 308, of wiper attachment 300. In general, the snaps may be configured to removably engage with the gear cover, e.g., to securely, yet removably, couple wiper attachment 300 to gear cover 210.

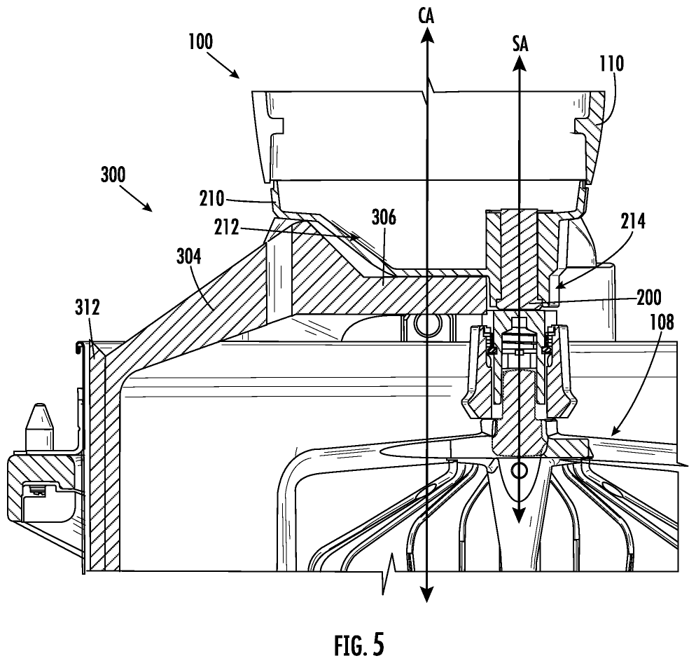

Referring now to FIG. 5, illustrated is a side, section view of wiper attachment 300 attached to a section of an example embodiment of stand mixer 100. As stated above, scraper 312 may be generally configured to continuously contact bowl 98 of stand mixer 100 during mixing processes, e.g., a mixing process may include rotating the mixer and the gear cover, thereby the scraper may continuously contact the bowl throughout the entire revolution, e.g., three hundred and sixty degrees (360°). In order to achieve continuous contact, wiper attachment 300 is coupled to gear cover 210 of stand mixer 100 such that wiper attachment 300 rotates around central axis CA of stand mixer 100. In particular, when bowl 98 is mounted on stand mixer 100, bowl 98 may be centered about central axis CA such that during mixing processes, scraper 312 may make continuous contact with bowl 98 while wiper attachment 300 rotates within bowl 98.

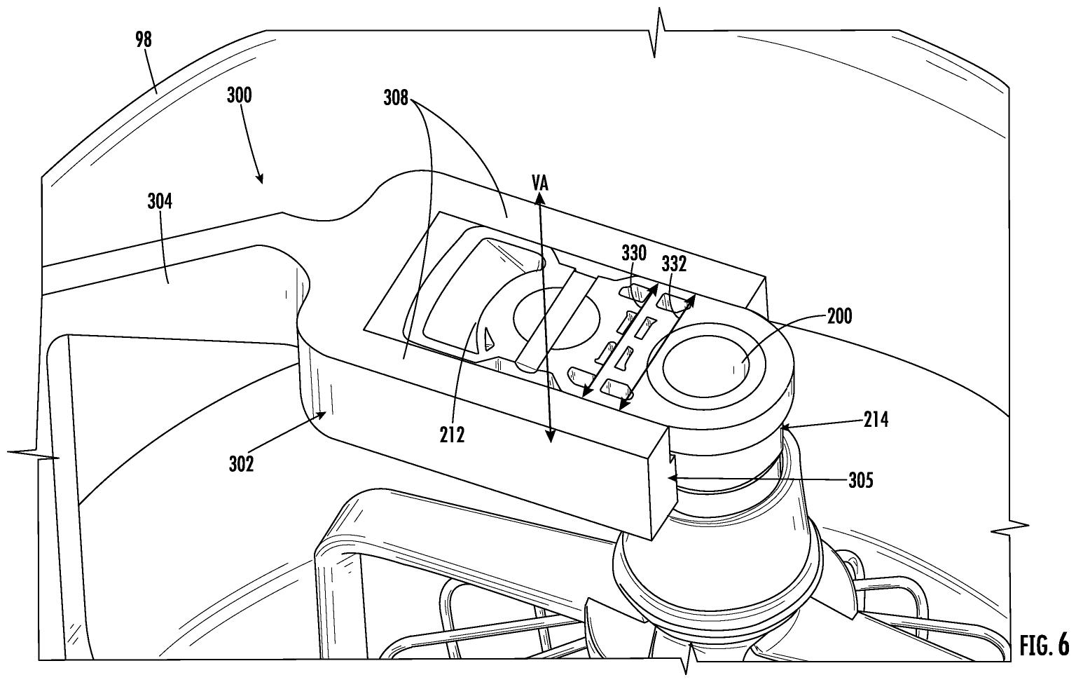

Turning now to FIG. 6, a perspective, section view of wiper attachment 300 attaching to stand mixer 100 is shown, e.g., specifically the section of the wiper attachment 300 and stand mixer 100 is taken along a horizonal plane generally defined by defined by the lateral direction L and transverse direction T at the pair of opposing sidewalls 308. As stated above, gear cover 210 may include a body portion 212. In particular, body portion 212 may be defined in gear cover 210 at a first specified width 330. When wiper attachment 300 couples to gear cover 210, the pair of opposing sidewalls 308 engages body portion 212 of gear cover 210 such that undesired rotation of wiper attachment 300 around vertical axis VA may be reduced, e.g., positioning wiper attachment 300 in two directions of movement on the gear cover. In particular, the undesired rotation of wiper attachment 300 may be rotation of wiper attachment 300 relative to gear cover 210. As such, the pair of opposing sidewalls 308 of seat portion 302 of wiper attachment 300 may be spaced at a second specified width 332. For example, second specified width 332 may be no less than first specified width 330, such that the pair of opposing sidewalls 308 securely engages with first specified width 330 of body portion 212 of gear cover 210.

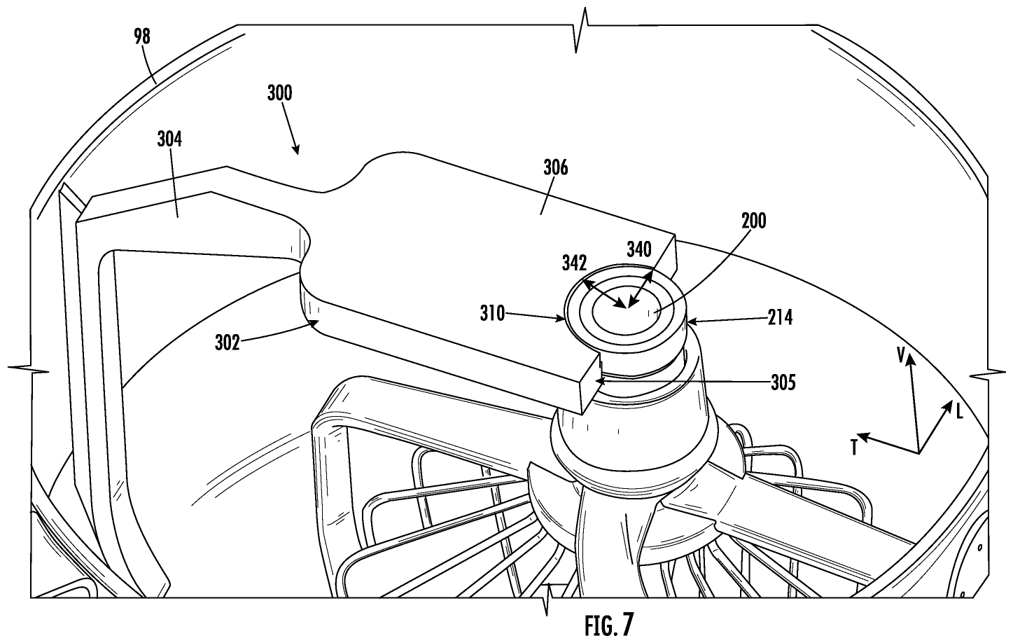

Shown in FIG. 7 is another perspective, section view of wiper attachment 300 attaching to stand mixer 100, e.g., specifically the section of the wiper attachment 300 and stand mixer 100 is taken along a horizonal plane generally defined by defined by the lateral direction L and transverse direction T at the floor 306. As stated above, gear cover 210 may include a round shaft portion 214. In particular, round shaft portion 214 may be defined in gear cover 210 at a first specified radius 340. When wiper attachment 300 couples to gear cover 210, the semicircular opening 310 may engage round shaft portion 214 of gear cover 210 such that horizontal translation of wiper attachment 300 may be reduced, such as translation of the wiper attachment in a horizontal plane defined by the lateral direction L and transverse direction T. Thus, the engagement of the semicircular opening 310 on the round shaft portion 214 may position wiper attachment 300 in four directions of movement, e.g., left and right in the lateral direction L and forward and backwards along the transverse direction T. As such, the semicircular opening of seat portion 302 of wiper attachment 300 may be at a second specified radius 342. For example, the second specified radius 342 may be no less than first specified radius 340, such that the semicircular opening 310 securely engages with first specified radius 340 of round shaft portion 214 of gear cover 210.

As may be seen from the above, a stand mixer may include a removable wiper attachment. Magnets may couple the body of the wiper attachment to a gear cover of the stand mixer. The width of the gear cover may be used as a two-way locator and the diameter of an output shaft may be used as a four-way locator. Thus, the two-way and four-way locators positively position the wiper attachment. The wiper attachment may be removably coupled onto the gear cover, either with the magnets or using snaps. A half circle or semicircular opening on an end of the wiper attachment may be the four-way locator and may assist in removing the wiper attachment without having to remove any other components. Seating the half circle against the round portion of the gear cover may reduce translation in four directions of movement, and seating the width of the wiper attachment against the width portion of the cover stops another two direction of movement. Accordingly, two-way and four-way locators ensure the wiper attachment is centered and makes consistent contact with a bowl of the stand mixer, which may advantageously increase customer satisfaction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer defining a vertical direction, a lateral direction and a transverse direction, the vertical, lateral, and transverse directions being mutually perpendicular, the stand mixer comprising:
a housing;
a motor disposed in the housing;
a mixing shaft operably coupled to the motor;
a gear cover coupled around the mixing shaft; and
a wiper attachment removably coupled to the gear cover, the wiper attachment comprising:
a seat portion, the seat portion comprising a floor extending between a pair of opposing sidewalls; and
a blade extending from one end of the seat portion,
wherein the floor of the seat portion defines a semicircular opening at a distal end of the seat portion from the blade,
wherein the pair of opposing sidewalls and the semicircular opening of the seat portion of the wiper attachment are configured to engage with the gear cover in order to securely couple the wiper attachment to the gear cover.

2. The stand mixer of claim 1, further comprising a magnet positioned within the seat portion of the wiper attachment, the magnet configured to removably engage with the gear cover.

3. The stand mixer of claim 1, further comprising a snap positioned on the seat portion of the wiper attachment, the snap configured to removably engage with the gear cover.

4. The stand mixer of claim 1, further comprising body portion of a first specified width defined in the gear cover, wherein the pair of opposing sidewalls of the seat portion of the wiper attachment are spaced at a second specified width, the second specified width no less than the first specified width whereby the pair of opposing sidewalls engages the first specified width of the body portion of the gear cover.

5. The stand mixer of claim 4, wherein, when the wiper attachment is coupled to the gear cover, the pair of opposing sidewalls engages the body portion of the gear cover, thereby reducing rotation of the wiper attachment relative to the gear cover around a vertical axis.

6. The stand mixer of claim 1, further comprising a round shaft portion of a first specified radius defined in the gear cover, wherein the semicircular opening of the seat portion of the wiper attachment defines a second specified radius, the second specified radius no less than the first specified radius such that the semicircular opening of the seat portion engages the first specified radius of the round shaft portion of the gear cover.

7. The stand mixer of claim 6, wherein, when the wiper attachment is coupled to the gear cover, the semicircular opening engages the round shaft portion of the gear cover, thereby reducing translation of the wiper attachment relative to the gear cover in the lateral direction and transverse direction.

8. The stand mixer of claim 1, wherein the wiper attachment removably couples to the gear cover such that the wiper attachment is rotatable around a central axis of the stand mixer.

9. The stand mixer of claim 1, wherein the wiper attachment comprises a scraper extending from an outer portion of the blade, wherein the scraper continuously contacts a bowl of the stand mixer throughout an entire revolution of the mixing shaft.

10. A wiper attachment for a stand mixer, the wiper attachment defining a vertical direction, a lateral direction and a transverse direction, the vertical, lateral, and transverse directions being mutually perpendicular, the wiper attachment removably coupled to a gear cover of the stand mixer, the wiper attachment comprising a seat portion and a blade extending from one end of the seat portion, the seat portion comprising a floor extending between a pair of opposing sidewalls, the floor defining a semicircular opening at a distal end of the seat portion from the blade, wherein the pair of opposing sidewalls, and the semicircular opening of the seat portion of the wiper attachment are configured to engage with the gear cover in order to securely couple the wiper attachment to the gear cover.

11. The wiper attachment of claim 10, further comprising a magnet positioned within the seat portion of the wiper attachment, the magnet configured to removably engage with the gear cover.

12. The wiper attachment of claim 10, further comprising a snap positioned on the seat portion of the wiper attachment, the snap configured to removably engage with the gear cover.

13. The wiper attachment of claim 10, further comprising a body portion of a first specified width defined in the gear cover, wherein the pair of opposing sidewalls of the seat portion of the wiper attachment are spaced at a second specified width, the second specified width no less than the first specified width such that the pair of opposing sidewalls engages the first specified width of the body portion of the gear cover.

14. The wiper attachment of claim 13, wherein, when the wiper attachment is coupled to the gear cover, the pair of opposing sidewalls engages the body portion of the gear cover, thereby reducing rotation of the wiper attachment relative to the gear cover around a vertical axis.

15. The wiper attachment of claim 10, further comprising a round shaft portion of a first specified radius defined in the gear cover, wherein the semicircular opening of the seat portion of the wiper attachment defines a second specified radius, the second specified radius no less than the first specified radius such that the semicircular opening of the seat portion engages the first specified radius of the round shaft portion of the gear cover.

16. The wiper attachment of claim 15, wherein, when the wiper attachment is coupled to the gear cover, the semicircular opening engages the round shaft portion of the gear cover, thereby reducing translation of the wiper attachment relative to the gear cover in the lateral direction and transverse direction.

17. The wiper attachment of claim 10, wherein the wiper attachment removably couples to the gear cover such that the wiper attachment rotates around a central axis of the stand mixer.

18. The wiper attachment of claim 10, wherein the wiper attachment comprises a scraper extending from an outer portion of the blade, the scraper configured to continuously contact a bowl of the stand mixer throughout an entire revolution of a mixing shaft of the stand mixer.
